(19) United States
(12) Patent Application Publication
(10) Pub. No.: US 2003/0048150 A1
(43) Pub. Date: Mar. 13, 2003

(54) Method for reducing crosstalk of analog crossbar switch by balancing inductive and capacitive coupling

(76) Inventors: William L. Clarke, Soquel, CA (US); Jules D. Levine, Santa Clara, CA (US)

Correspondence Address: PATENT ADMINSTRATOR, KATTEN MUCHIN ZAVIS ROSENMAN, 525 WEST MONROE STREET, SUITE 1600, CHICAGO, IL, 60661-3693, US

(21) Appl. No.: 09/949,935

(22) Filed: Sep. 12, 2001

(51) Int. Cl. H01P 1/10

(52) U.S. Cl. 333/101

(57) ABSTRACT

A method for suppressing crosstalk in a telecommunications switching array is provided. The array includes a plurality of first transmission lines for accepting incoming signals, a plurality of second transmission lines for propagating outgoing signals, a plurality of switches, and a plurality of inductive couplings. The first transmission lines are arranged substantially in parallel to each other, and each of the first transmission lines has a characteristic impedance substantially equal to Z₀. The second transmission lines are arranged substantially perpendicularly to the first transmission lines so as to form an intersection between each of the first transmission lines and each of the second transmission lines, and each of the second transmission lines has a characteristic impedance substantially equal to Z₀. Each intersection includes one of the switches. Each of the switches is switchable between an ON state and an OFF state, and each of the switches has a characteristic parasitic capacitance substantially equal to Cₘ when in the OFF state. Each of the inductive couplings is associated with one of the switches, and each of the inductive couplings has a characteristic inductance substantially equal to Lₘ. The value of Lₘ is chosen so as to compensate for the parasitic capacitances such that suppression of crosstalk within the array is increased. The value of Lₘ may be chosen such that the equation Lₘ/Cₘ=Z₀² is satisfied. The choice of the value of Lₘ may be such that backwards coupling of the crosstalk occurs and the crosstalk is absorbed by a plurality of transmission line terminators. Each of the switches may have a characteristic series resistance substantially equal to Rₒₙ when in the ON state, thus causing a local impedance substantially equal to Z_{local} to be created at each of the plurality of switches when in the ON state. A value of Rₒₙ may be chosen such that a mismatch between the local impedance Z_{local} and the characteristic impedance Z₀ of each of the plurality of first and second transmission lines is reduced.

### BACKGROUND OF THE INVENTION

1. Field of the Invention

The present invention relates to transmission lines being used for a telecommunications system, and more particularly to a method for reducing crosstalk created by capacitive coupling between the transmission lines.

2. Description of the Related Art

Referring to FIG. 1, an N×M crossbar switch 100 includes N parallel transmission lines 105, forming N rows, and M parallel lines 110, forming M columns, oriented substantially perpendicularly to the rows. An example of such a crossbar switch array is described in U.S. patent application Ser. No. 09/788,296, filed on Aug. 25, 2000, and entitled “Telecommunications Switching Array Using Thyristor Addressing V.5”, is incorporated herein by reference.

At each of the intersection points on the N×M crossbar switch 100, there is located a semiconductor switch 115 which, when turned on, allows a signal incoming on a row to be directed to an arbitrary column. When a switch 115 is used as a permutation switch, any given incoming signal can be directed to an arbitrary outgoing column by turning on the switch at the intersection of that row and column, and placing all the other switches at the N−1 remaining crossbar points of the outgoing column in the off state. Because each switch in the off state has a residual parasitic capacitance, all of the other incoming signals are capacitively coupled to the outgoing column, resulting in crosstalk. Since the signals on the other inputs are uncorrelated to the given input signal, this crosstalk will appear as noise, and will degrade the overall noise margin of the system.

In a well designed analog crossbar switch with well isolated transmission lines, this capacitive coupling due to the switch capacitance will be a limiting factor in determining the maximum size possible for a given noise margin. Accordingly, there is a need for a method for reducing this capacitive coupling of spurious crosstalk into the outgoing signal channels.

### SUMMARY OF THE INVENTION

The present invention addresses the need for a method for reducing capacitive coupling of spurious crosstalk into outgoing signal channels in an analog crossbar switch array.

In one aspect, the invention provides a telecommunications switching array. The array includes a plurality of first transmission lines for accepting incoming signals, a plurality of second transmission lines for propagating outgoing signals, a plurality of switches, and a plurality of inductive couplings. The first transmission lines are arranged substantially in parallel to each other, and each of the first transmission lines has a characteristic impedance substantially equal to Z₀. The second transmission lines are arranged substantially perpendicularly to the first transmission lines so as to form an intersection between each of the first transmission lines and each of the second transmission lines, and each of the second transmission lines has a characteristic impedance substantially equal to Z₀. Each intersection includes one of the switches. Each of the switches is switchable between an ON state and an OFF state, and each of the switches has a characteristic parasitic capacitance substantially equal to Cₘ when in the OFF state. Each of the inductive couplings is associated with one of the switches, and each of the inductive couplings has a characteristic inductance substantially equal to Lₘ. The value of Lₘ is chosen so as to compensate for the parasitic capacitances such that suppression of crosstalk within the array is increased.

The value of Lₘ may be chosen such that the equation Lₘ/Cₘ=Z₀² is satisfied. The array may have an even transverse electromagnetic (TEM) mode and an odd TEM mode, where the even TEM mode is associated with a characteristic impedance substantially equal to Zₑᵥₑₙ, and the odd TEM mode is associated with a characteristic impedance substantially equal to Z_{odd}, such that the equation Zₑᵥₑₙ*Z_{odd}=Z₀² is satisfied. The choice of the value of Lₘ so as to compensate for the parasitic capacitances such that suppression of crosstalk within the array is increased may include a choice of the value of Lₘ such that backwards coupling of the crosstalk occurs and the crosstalk is absorbed by a plurality of transmission line terminators. For example, when Z₀=approximately 50 Ω and Cₘ=approximately 10 fF, Lₘ may be chosen to be approximately equal to 25 pH.

Each of the switches may have a characteristic series resistance substantially equal to Rₒₙ when in the ON state, thus causing a local impedance substantially equal to Z_{local} to be created at each of the plurality of switches when in the ON state. A value of Rₒₙ may be chosen such that a mismatch between the local impedance Z_{local} and the characteristic impedance Z₀ of each of the plurality of first and second transmission lines is reduced. For example, when Z₀=approximately 50 Ω and Cₘ=approximately 10 fF, Lₘ may be chosen to be approximately equal to 25 pH, and Rₒₙ may be chosen to be approximately equal to 21 Ω.

The array may also include a multilevel monolithic integrated circuit having a substrate. The circuit may include a plurality of unit cells. Each unit cell may include one of the switches, a row trace associated with one of the first transmission lines, and a column trace associated with one of the second transmission lines. Each of the switches may include a semiconductor switch, such as a thyristor. Each unit cell may also include a first layer and a second layer of a dielectric material having a low dielectric constant, where the first layer of dielectric material is deposited upon the substrate, and the second layer of dielectric material is deposited upon the first layer of dielectric material. The row trace included within each unit cell may be fabricated upon the substrate such that a lower loop is formed. The column trace included within each unit cell may be fabricated upon the second layer of dielectric material such that an upper loop is formed. The first layer of dielectric material may act as an insulating layer in between the upper loop and the lower loop. A combination of the upper loop and the lower loop in each unit cell may create the inductive coupling associated with the switch included within the same unit cell. The substrate may include gallium arsenide.

In another aspect, the invention provides a method of increasing suppression of crosstalk in a telecommunications switching array. The array includes a plurality of first transmission lines for accepting incoming signals, a plurality of second transmission lines for propagating outgoing signals, and a plurality of switches. The first transmission lines are arranged substantially in parallel to each other, and each of the first transmission lines has a characteristic impedance substantially equal to Z₀. The second transmission lines are arranged substantially perpendicularly to the first transmission lines so as to form an intersection between each of the first transmission lines and each of the second transmission lines. Each of the plurality of second transmission lines having a characteristic impedance substantially equal to Z₀. Each intersection includes one of the switches. Each of the switches is switchable between an ON state and an OFF state. Each of the plurality of switches has a characteristic parasitic capacitance substantially equal to Cₘ when in the OFF state. The method includes the steps of providing each of the switches with an inductive coupling having a characteristic inductance substantially equal to Lₘ, and selecting a value of Lₘ so as to compensate for the parasitic capacitances within the array.

The step of selecting a value of Lₘ may include satisfying the equation Lₘ/Cₘ=Z₀². The array may have an even transverse electromagnetic (TEM) mode and an odd TEM mode, where the even TEM mode is associated with a characteristic impedance substantially equal to Zₑᵥₑₙ, and the odd TEM mode is associated with a characteristic impedance substantially equal to Z_{odd}. The method may also include the step of satisfying the equation Zₑᵥₑₙ*Z_{odd}=Z₀². The step of selecting a value of Lₘ so as to compensate for the parasitic capacitances within the array may include selecting a value of Lₘ such that backwards coupling of crosstalk occurs and the crosstalk is absorbed by a plurality of transmission line terminators. For example, when Z₀=approximately 50 Ω and Cₘ=approximately 10 fF, the step of selecting a value of Lₘ so as to compensate for the parasitic capacitances within the array may include selecting Lₘ to be approximately equal to 25 pH.

Each of the switches may have a characteristic series resistance substantially equal to Rₒₙ when in the ON state, thus causing a local impedance substantially equal to Z_{local} at each of the switches when in the ON state. The method may also include the step of selecting a value of Rₒₙ such that a mismatch between the local impedance Z_{local} and the characteristic impedance Z₀ of each of the first and second transmission lines is reduced. For example, when Z₀=approximately 50 Ω and Cₘ=approximately 10 fF, the step of selecting a value of Lₘ so as to compensate for the parasitic capacitances within the array may include selecting Lₘ to be approximately equal to 25 pH, and the step of selecting a value of Rₒₙ such that a mismatch between the local impedance Z_{local} and the characteristic impedance Z₀ of each of the first and second transmission lines is reduced may include selecting Rₒₙ to be approximately equal to 21 Ω.

The method may also include the step of implementing the array as a multilevel monolithic integrated circuit having a substrate. The circuit may include a plurality of unit cells. Each unit cell may include one of the switches, a row trace associated with one of the first transmission lines, and a column trace associated with one of the second transmission lines. Each of the switches may include a semiconductor switch, such as a thyristor. Each unit cell may also include a first layer and a second layer of a dielectric material having a low dielectric constant, where the first layer of dielectric material is deposited upon the substrate, and the second layer of dielectric material is deposited upon the first layer of dielectric material. The step of implementing the array as a multilevel monolithic integrated circuit may include the steps of fabricating the row trace included within each unit cell upon the substrate such that a lower loop is formed, fabricating the column trace included within each unit cell upon the second layer of dielectric material such that an upper loop is formed, using the first layer of dielectric material as an insulating layer in between the upper loop and the lower loop, and combining the upper loop and the lower loop in each unit cell to create the inductive coupling associated with the switch included within the same unit cell. The substrate may include gallium arsenide.

### BRIEF DESCRIPTION OF THE DRAWINGS

FIG. 1 is schematic diagram of an N×M crossbar switch.

FIG. 2 is a graph of a capacitive cross coupling effect as a function of frequency for the crossbar switch of FIG. 1.

FIG. 3 is a circuit diagram of an individual switch node of the crossbar switch of FIG. 1.

FIG. 4 is a circuit diagram of a backwards coupler, including a coupled pair of transmission lines.

FIG. 5 is a circuit diagram of a 2×2 crosspoint array with mutual inductive and capacitive coupling at each intersection point.

FIG. 6 is a circuit diagram of a 2×2 crossbar permutation switch.

FIG. 7 is a graph of a capacitive cross coupling response as a function of frequency for a backwards coupled 4×4 crossbar switch array.

FIG. 8 is a graph of a capacitive cross coupling response as a function of frequency for a 4×4 crossbar permutation switch with inductive coupling Lₘ=25 pH.

FIG. 9 is a graph of a capacitive cross coupling response as a function of frequency for a 4×4 crossbar permutation switch with inductive coupling Lₘ=0.

FIG. 10 is a top view of an upper loop of a unit cell of a monolithic switch array.

FIG. 11 is a top view of a lower loop of the unit cell of the monolithic switch array of FIG. 10.

FIG. 12 is a side view of the unit cell of the monolithic switch array of FIG. 10.

### DETAILED DESCRIPTION OF THE INVENTION

The present inventors have recognized the need for a method for reducing capacitive coupling of spurious crosstalk into outgoing signal channels in an analog crossbar switch array. Accordingly, the proposed invention is an improvement on existing crossbar switches which gives better isolation and a greater signal to noise ratio than otherwise possible.

The invention teaches a method for improving the noise margin of an analog crossbar switch by reducing the capacitive coupling of unwanted input signals into the outputs caused by the parasitic capacitance of the crosspoint switch elements which are in the off state.

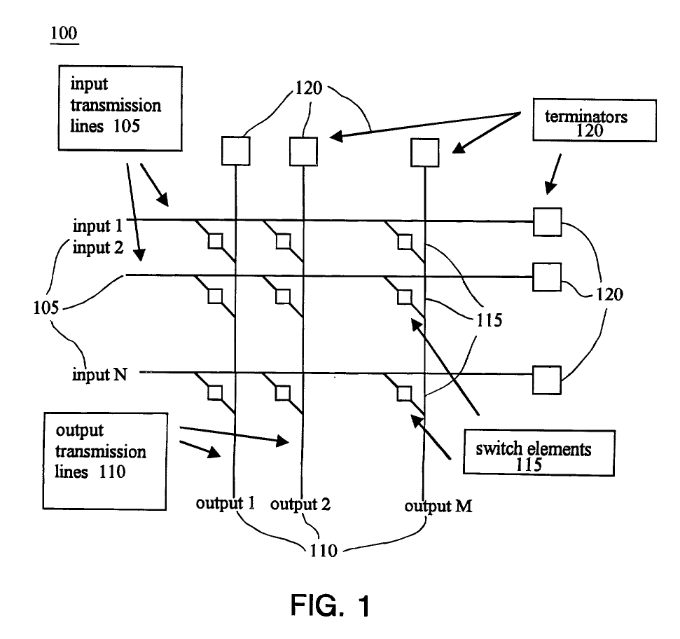

FIG. 1 shows a schematic diagram of an N×M crossbar switch 100, with N×M crosspoint switch elements 115. The input signals are incoming on N transmission lines 105 which comprise the rows of the switch, and the M output signals are outgoing on M transmission lines 110 which form the columns. At the intersection of each row and column there is a crosspoint switch element 115, which can be turned “on” or “off”. Any given signal incoming on a given row 105 can be directed to an open column 110 by turning on the switch at the intersection of that row and column. For any column 110, only one switch 115 can be in the on state, all others must be off. The transmission lines forming the rows and columns each have characteristic impedance Z₀. The input lines are driven by sources of output impedance Z₀, and the output lines drive devices with input impedance Z₀. The other side of each of the lines is terminated by a resistive terminator 120 having an impedance of Z₀ ohms.

When a signal incoming on a given row N′ is switched to a given column M′, the crosspoint switch at the intersection of row N′ and column M′ is in the “on” state with series resistance Rₒₙ. All the other crosspoint switches connected to that column are in the “off” state, with parasitic capacitance Cₘ. This parasitic capacitance couples signal energy from the remaining rows into column M′; because the incoming signals on these remaining rows are uncorrelated with the signal incoming on row N′, this spurious coupling will appear as noise on the output M′. The total amount of this coupled signal energy will determine the noise margin of the switch. An analytical formula for the cross coupling power at a single crosspoint node due to this parasitic capacitance is given by

Cross coupling=(¼) (ωCₘZ₀)²/[1+(ωCₘZ₀)²] (Equation 1),

where

ω=2πf is the angular frequency;

Cₘ=parasitic capacitance of the crosspoint switch; and

Z₀=characteristic impedance of the lines.

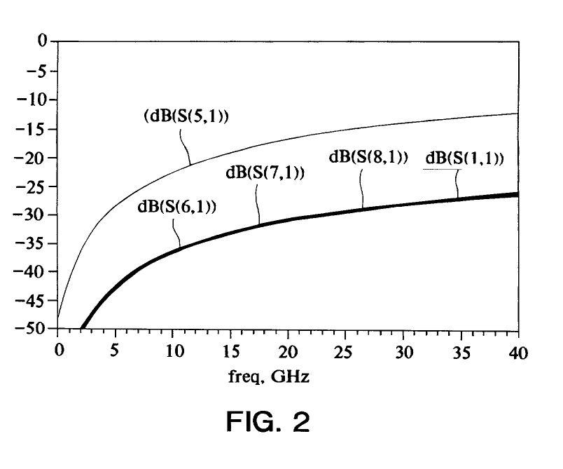

Referring to FIG. 2, the formula of Equation 1 shows that the coupled crosstalk has an approximately quadratic dependence on frequency, resulting in the characteristic “capacitive” response shown in the lower graph of FIG. 2, as plotted on a logarithmic scale (dB). The scaling constant is the switch capacitance Cₘ. Hence, the switch capacitance must be reduced as much as possible to minimize crosstalk. However, for a given semiconductor process, there will be a lower limit on the off state capacitance of the switching device, so that the method of further reducing the cross coupling described here will result in additional suppression of the spurious noise-like crosstalk, thereby increasing the system noise margin for a given process technology.

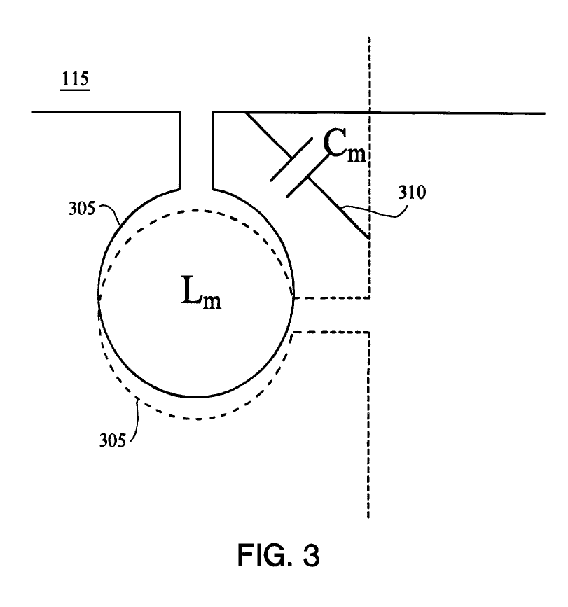

In the method of this invention, the spurious coupling is suppressed by adding series-connected, mutual inductors at every node which further couple a given row and column at a crosspoint. Referring to FIG. 3, an equivalent circuit is shown of a node 115 of FIG. 1 in which the switch element is in the “off” state. Additional mutual inductors 305 are connected in series with the incoming and outgoing lines. This additional inductive coupling Lₘ 305, in conjunction with the parasitic capacitive coupling Cₘ 310 of the switch element 115, causes an asymmetry of the coupling between rows and columns. For example, in FIG. 3, assuming the signal is incoming from the left, most of the spuriously coupled signal propagates upward due to this asymmetry, and the signal is absorbed by the terminator 120 at the top of a given column (referring again to FIG. 1). Very little of the cross coupled signal is directed downward to the output of the switch, where it appears as crosstalk. This configuration acts as a “backwards wave coupler” [1] at each node, because the spuriously coupled signal is coupled “backwards” into the terminator at the top of the column, where it is absorbed, and not “forwards” into the output of the switch.

Design of Backwards Wave Couplers

The theory of broadband backwards wave couplers is well developed for coupled transmission lines [2]. FIG. 3 shows the equivalent circuit of two coupled transmission lines. The infinitesimal periodic structure parameterized by L, C models the transmission lines, and the mutual inductive and capacitive coupling is modeled by the periodic Lₘ, Cₘ structure. The following two conditions are necessary and sufficient to guarantee that the signal coupled to the adjacent transmission line will travel in a direction opposite to the incoming signal, i.e. a backwards wave:

Lₘ/Cₘ=L/C=Z₀² (Equation 2)

Zₑᵥₑₙ*Z_{odd}=Z₀² (Equation 3)

where Zₑᵥₑₙ and Z_{odd} are the even and odd (normal) modes of the coupled system, respectively, and Z₀ is the characteristic impedance of the lines.

Compliance with Equations 2 and 3 guarantees that the even and odd modes propagate at the same velocities and that they both are transverse electromagnetic (TEM) in nature. When these conditions are satisfied, any crosstalk between the two lines propagates in a direction opposite to the signal, so that the forward coupling is identically zero, leading to perfect isolation. Typically, these conditions are rather easy to achieve for low dielectric substrates.

Backwards Coupling in a Crosspoint Array

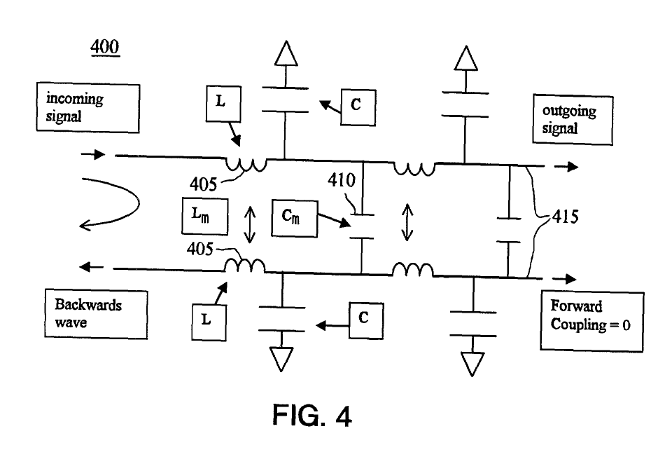

Referring to FIG. 4, it is possible to build a backwards coupler 400 out of discrete components Lₘ 405, Cₘ 410, which will function approximately as the coupled transmission lines 415 shown in FIG. 4. Furthermore, a crosspoint array which is coupled by a capacitance Cₘ at each node can be built which will exhibit backwards wave behavior. For example, in FIG. 4, the bottom transmission line can be rotated 90 degrees clockwise, so that the backwards wave coupled from the incoming signal line is propagated upwards.

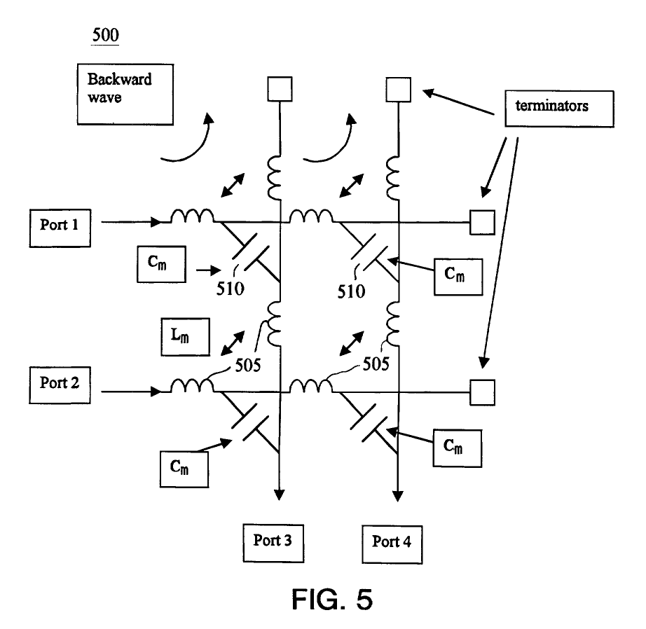

Referring to FIG. 5, a 2×2 crosspoint array 500 with mutual inductive coupling 505 and capacitive coupling 510 at each crosspoint is shown. The capacitive coupling Cₘ 510 is the residual parasitic capacitance of each crosspoint switch when it is in the off state. At each node, the combination of Lₘ, Cₘ acts exactly as a the Lₘ, Cₘ shown in FIG. 4, where the row segment of the array corresponds to a segment of the top line of FIG. 4 (incoming line), and the column segment corresponds to a segment of the bottom row, rotated 90 degrees clockwise. The sense of the rotation (i.e., the fact that a clockwise 90 degree rotation results in the backwards wave traveling up) is determined by the order Lₘ, Cₘ in the array. In the case of FIG. 5, as the incoming signal propagates along a row, it first encounters the mutual inductance Lₘ 505, then the mutual capacitance Cₘ 510. Hence, the direction of the backwards wave is well defined as being upwards for FIG. 5. A downwards coupler can be constructed by reversing the order of of Lₘ, Cₘ in the array.

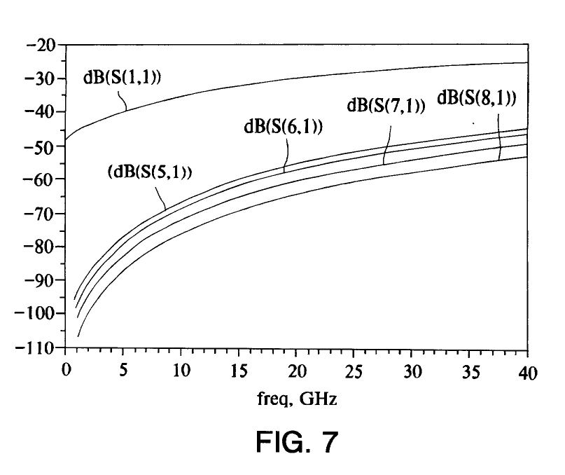

Note that the foregoing argument is also valid for the general case of an N×M crossbar switch. Using a typical “off” switch capacitance of 10 fF (1 fF=10⁻¹⁵ Farads), Equation 1 is satisfied when Lₘ=25 pH (1 pH=10⁻¹² Henries), and Z₀=50 ohms. By analogy to FIG. 4, it may be seen that when Equations 2 and 3 are satisfied, the coupling between rows and columns is “backwards”, in this case upwards. There is a sharp minimum in coupling between the incoming and outgoing signals when Lₘ/Cₘ=Z₀, that is, most of the coupled signal is directed upwards and absorbed by the terminators at the top of the columns. Referring to FIG. 7, this suppression of forward (i.e., downward) crosstalk is intrinsically broadband, as can be seen in the response curve of FIG. 7 for a 4×4 backwards coupled array.

Note that in FIG. 5, the ports are numbered by the following convention: Port 1 corresponds to input signal 1, incoming on the left side of the first row; and the numbering then continues counterclockwise, so that Port 2 corresponds to input 2, and Ports 3 and 4 correspond to the signal outputs. Now, for a 4×4 array, the ports are also numbered counterclockwise, starting from input 1 at the left of row 1. That is, ports 1, 2, 3, and 4 are inputs, and ports 5, 6, 7, and 8 are outputs. S(8,1) is the output at port 8 produced by a unit signal at port 1, assuming all other ports are terminated with zero input. Referring again to FIG. 7, the simulation of a 4×4 backwards wave crosspoint array, the crosstalk may be seen to be capacitive, as in FIG. 2, but it is seen that it is strongly suppressed, by at least 20 dB. In the case of FIG. 5, all crosspoint switches are off, and the backwards wave effect is seen most clearly. It is noted that the return loss is also reduced, showing that the mismatch caused by the switch capacitance is mitigated. It is also noted that for the longer paths through the switch, e.g. S(8,1), the crosstalk is more strongly suppressed compared to the shorter paths, e.g. S(5,1). This is due to the fact that for the shortest path S(5,1), the cross coupling point is furthest to the left, and therefore it receives the reflected signal (return loss) from all coupling points to its right. This reflected signal is then coupled into the output lines and appears as crosstalk. Similarly, the longest path S(8,1) has no coupling points to its right, so does not receive any reflected signal, so no additional crosstalk is coupled to the output. Finally, any signal coupled from the output (vertical) transmission lines will propagate to the left or right, where it will be absorbed in the terminators. Hence, the vertical output lines will contribute no crosstalk.

Backwards Coupling in a Permutation Switch

The method of this invention uses the backwards coupling effect to minimize crosstalk by causing the coupled signal to propagate “backwards”, i.e., assuming the signal is incoming from the left, to couple upwards, away from the output, thereby suppressing the crosstalk. However, if the signal is propagating from right to left, as in the case of a signal reflected from a mismatch in the line, then the signal is already traveling “backwards”, and so backwards coupling will result in the signal being propagated “forward”, i.e. downward into the outputs. This will reduce the suppression of crosstalk already achieved. Hence, reflections of the incoming signals must be reduced as much as possible by reducing all mismatches on the incoming and outgoing transmission lines.

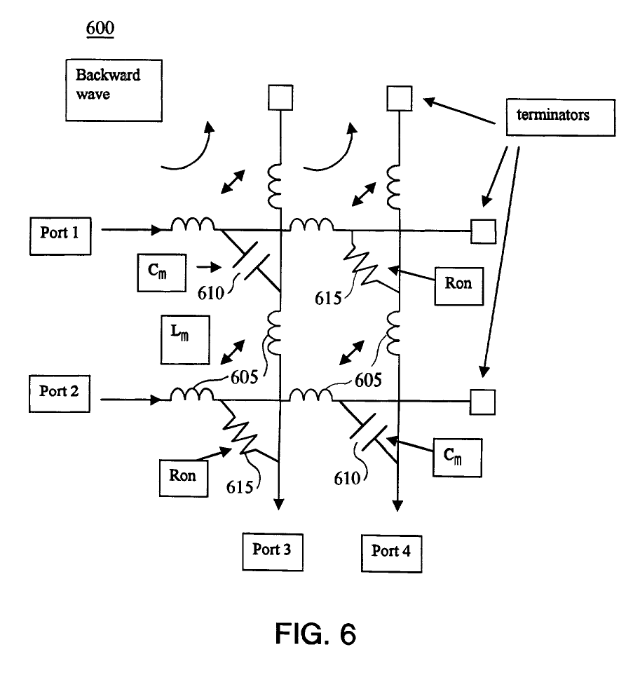

In the previous example using FIG. 5, all crosspoint switches were in the off state, resulting in weak reflections along the line; hence, crosstalk was strongly suppressed by the backwards coupling technique. However, for a permutation switch, such as the 2×2 crossbar permutation switch 600 shown in FIG. 6, exactly one switch per row (column) will be in the on state in order to redirect the incoming signal along a given row to an arbitrary outgoing column. In FIG. 6, the “off” switches are modeled by a capacitance Cₘ 610, and the “on” switches are modeled by a series resistance Rₒₙ 615. For a small switch resistance Rₒₙ 615, this will effectively short the incoming and outgoing transmission lines at the given crosspoint, resulting in a local mismatch. This mismatch will cause strong reflections, which will then be propagated to the outputs by backwards coupling as discussed previously. Also, the signal redirected by the “on” switch will experience strong insertion loss as a result of this mismatch, and this insertion loss effect will further reduce system noise margin. Indeed, for a switch resistance Rₒₙ of zero, the power will split four ways at the “on” crosspoint, with ¼ of the power being reflected backwards, ¼ of the power being redirected to the appropriate output column, and the other ½ of the power being absorbed by the terminators and wasted. This implies that the local impedance measured at the on switch will be Z₀/3, i.e., about 17 ohms, assuming standard 50 ohm transmission lines.

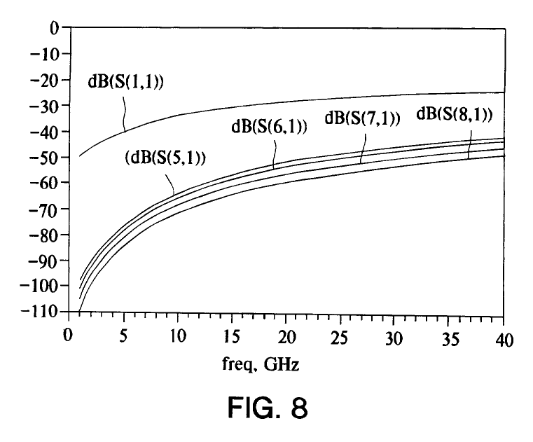

It is possible to fabricate a semiconductor crossbar switch that does not have zero “on” resistance, Rₒₙ, so the transmission lines are not completely shorted to the “on” junction. For a typical value of Rₒₙ=12 ohms, the impedance measured at the switch junction will be about 21 ohms. This increases insertion loss, but it also produces a better match. Referring to FIG. 8, the return loss and crosstalk curves are shown for a 4×4 permutation switch in which the diagonal switch elements are turned on and all other switch elements are in the off state. This implementation corresponds to the reverse permutation. It is seen that the return loss is only about 3 dB worse than the ideal case of FIG. 7, and the crosstalk is only about 4 dB worse than in FIG. 7. In the present case, a 10 fF off state switch capacitance Cₘ is again assumed, and Lₘ=25 pH is chosen to satisfy Equation 2.

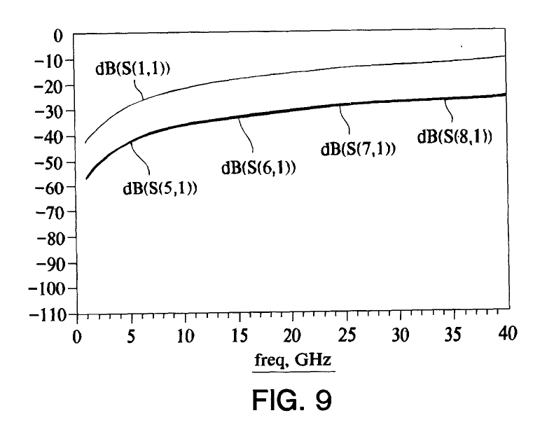

Referring to FIG. 9, the response is shown for the same permutation switch without the method of reducing crosstalk described in this invention, i.e., with Lₘ=0. It is noted that, without the benefit of the method of this invention, the same 4×4 permutation switch exhibits much worse performance; at 40 GHz, return loss has risen to −10 dB, and crosstalk has increased to −26 dB. This is to be compared with the results using the method of the invention, with Lₘ=25 pF. In that case, as shown in FIG. 8, return loss at 40 GHz is down to −24 dB, and crosstalk is reduced to −40 to −48 dB, a 14 to 22 dB improvement compared to the uncompensated case of FIG. 9. The method of this invention succeeds in substantially reducing the signal crosstalk in the permutation switch, even in the presence of the reflected signals caused by the mismatch at the “on” crosspoint junction.

The series “on” resistance at the switch crosspoint functions as a simple impedance matching device, so that the backwards wave coupling provided by the mutual inductors and mutual “off” switch capacitances act to suppress the spurious crosstalk on the output lines. This effect will be valid for any N×M crossbar permutation switch, and is not limited to the 4×4 case discussed here. In particular, the ability to suppress crosstalk in a large (e.g., 1024×1024) crossbar switch will increase system noise margins, reducing the bit error rate of digital data streams propagated through the switch. The optimal values of the series switch resistance Rₒₙ and inductive coupling Lₘ will vary with the values of N and M, i.e., the size of the permutation switch, and may be computed by standard optimization techniques.

Monolithic Design for Analog Crossbar Switch

Implementation of an analog crossbar switch array as a monolithic integrated circuit is possible using a low loss substrate and a process capable of multilevel structures. In other words, the rows and columns may be constructed on different levels so that they can cross without causing short circuits. A preferred embodiment of this invention is a multilevel monolithic integrated circuit in which the rows and columns are connected by semiconductor switches, such as thyristors, and in which there are provided mutual inductors at the intersection of each row and column so as to suppress the capacitive cross coupling, as described above. The following description is only one realization of the principle of reducing crosstalk by backwards wave coupling, and the scope of the invention should not be considered to be limited by the specific embodiment described below.

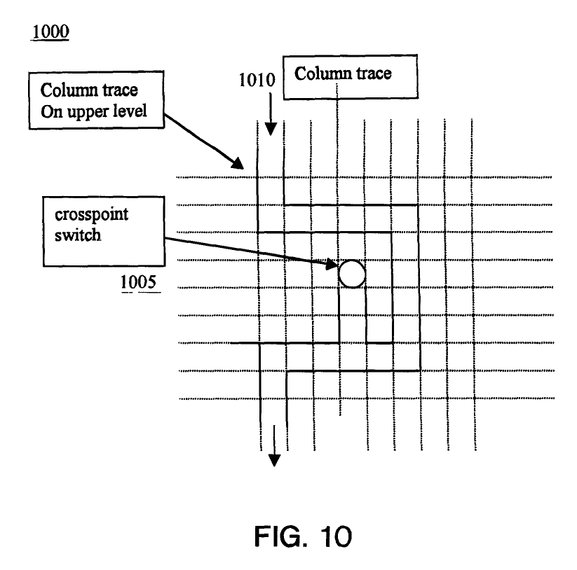

Referring to FIG. 10, a top view 1000 of the unit cell of a monolithic switch array is shown. The crosspoint switch 1005 is at the center of the unit cell, and the incoming column trace 1010 loops around the thyristor crosspoint switch as it extends from top to bottom, thus forming the upper loop of the mutual inductor required for the method of the invention. The column trace is fabricated on a plane just below the upper ground plane.

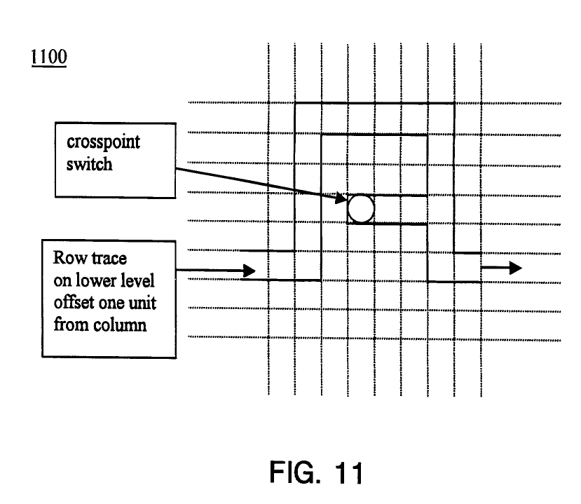

Referring to FIG. 11, a top view 1100 is shown of the lower loop, which is fabricated on a lower plane just above the lower ground plane. The two loops are fabricated on top of each other with a thin insulating layer in between the two loops, so that the mutual coupling of the two loops approaches unity. The two loops are offset so that their mutual capacitance is reduced. Small stubs connect the back wall of the loops to both ends of the switch. This structure is equivalent to the circuit of FIG. 3 when the thyristor switch is off. The mutual inductance of the upper and lower loops combines with the parasitic capacitance of the OFF thyristor switch to suppress crosstalk between the row and column traces.

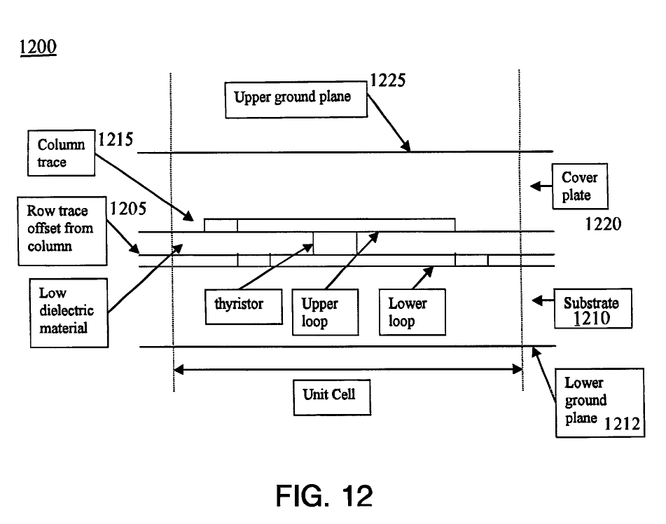

Referring to FIG. 12, a side view 1200 of the unit cell of the monolithic switch array is shown. The row traces 1205 of the switch are fabricated on the top surface of a substrate 1210, such as gallium arsenide (GaAs), where a conducting ground plane 1212 has been deposited on the bottom surface of the substrate 1210. The column traces 1215 are fabricated on a thin layer of low dielectric material which has been deposited on the substrate 1210. Finally, a cover plate 1220 having a similar dielectric material as the substrate 1210 is attached. The cover plate 1220 has an additional ground plane 1225 on its top surface. Hence, the row and column traces function as stripline, so the isolation between adjacent rows and adjacent columns is excellent, and signal dispersion is extremely low. This method is described in U.S. patent application Ser. No. 09/864,212, which was filed on May 25, 2001, and is entitled “A Microwave Crosspoint Switch Array With Coverplate That Minimizes Line-To-Line Crosstalk”, and which is incorporated herein by reference.

On the top surface of the substrate shown in FIG. 12, the row trace loops around the thyristor and attaches to the base of the thyristor to form the lower half of the switch. The transmission lines forming the columns are also fabricated as stripline on an additional low dielectric layer deposited over the first layer. The column loops around the thyristor and attaches to the top of the thyristor to form the upper half of the switch. The two loops are close enough to have appreciable mutual inductance, i.e., they are separated by a distance which is small compared to the size of the effective radius of the loops, but close enough to have a mutual coupling of approaching unity. The two loops may be offset to reduce their mutual capacitance.

The invention described here is based on a new development in directional coupler theory and practice, that is, backwards wave coupling in an analog crossbar switch. By using mutual inductors at each crosspoint, the mutual coupling between the rows and columns can be suppressed at the crosspoints where the switches are in the off state. This greatly reduces crosstalk, and has the potential to allow the fabrication of a very large (e.g. 1000×1000) switching array on a single chip and still retain an acceptable system nose margin and bit error rate.

While the present invention has been described with respect to what is presently considered to be the preferred embodiment, it is to be understood that the invention is not limited to the disclosed embodiments. To the contrary, the invention is intended to cover various modifications and equivalent arrangements included within the spirit and scope of the appended claims. For example, it is to be understood that the invention is applicable to any type of integrated circuit in which a crossbar switch using transmission lines arranged in rows and columns are connected by semiconductor switches. The scope of the following claims is to be accorded the broadest interpretation so as to encompass all such modifications and equivalent structures and functions.

What is claimed is:

1. A telecommunications switching array, comprising:
a plurality of first transmission lines for accepting incoming signals, the first transmission lines being arranged substantially in parallel to each other, and each of the plurality of first transmission lines having a characteristic impedance substantially equal to Z₀;
a plurality of second transmission lines for propagating outgoing signals, the second transmission lines being arranged substantially perpendicularly to the first transmission lines so as to form an intersection between each of the plurality of first transmission lines and each of the plurality of second transmission lines, and each of the plurality of second transmission lines having a characteristic impedance substantially equal to Z₀;
a plurality of switches, each of said intersections including one of the plurality of switches, each of the plurality of switches being switchable between an ON state and an OFF state, and each of the plurality of switches having a characteristic parasitic capacitance substantially equal to Cₘ when in the OFF state; and
a plurality of inductive couplings, each of the plurality of inductive couplings being associated with one of the plurality of switches, and each of the plurality of inductive couplings having a characteristic inductance substantially equal to Lₘ;
wherein the value of Lₘ is chosen so as to compensate for the parasitic capacitances such that suppression of crosstalk within the array is increased.

2. The array of claim 1, wherein Lₘ is chosen such that the equation Lₘ/Cₘ=Z₀² is satisfied.

3. The array of claim 2, the array having an even transverse electromagnetic (TEM) mode and an odd TEM mode, and the even TEM mode being associated with a characteristic impedance substantially equal to Zₑᵥₑₙ, and the odd TEM mode being associated with a characteristic impedance substantially equal to Z_{odd},
wherein the equation Zₑᵥₑₙ*Z_{odd}=Z₀² is satisfied.

4. The array of claim 1, the choice of the value of Lₘ so as to compensate for the parasitic capacitances such that suppression of crosstalk within the array is increased comprising a choice of the value of Lₘ such that backwards coupling of the crosstalk occurs and the crosstalk is absorbed by a plurality of transmission line terminators.

5. The array of claim 4, wherein when Z₀=approximately 50 Ω and Cₘ=approximately 10 fF, Lₘ is chosen to be approximately equal to 25 pH.

6. The array of claim 1, each of the plurality of switches having a characteristic series resistance substantially equal to Rₒₙ when in the ON state, and a local impedance substantially equal to Z_{local} being effected at each of the plurality of switches when in the ON state;
wherein Rₒₙ is chosen such that a mismatch between the local impedance Z_{local} and the characteristic impedance Z₀ of each of the plurality of first and second transmission lines is reduced.

7. The array of claim 6, wherein when Z₀=approximately 50 Ω and Cₘ=approximately 10 fF, Lₘ is chosen to be approximately equal to 25 pH, and Rₒₙ is chosen to be approximately equal to 21 Ω.

8. The array of claim 1, the array further comprising a multilevel monolithic integrated circuit having a substrate, the circuit including a plurality of unit cells, wherein each unit cell includes:
one of the plurality of switches;
a row trace associated with one of the plurality of first transmission lines; and
a column trace associated with one of the plurality of second transmission lines.

9. The array of claim 8, each of the plurality of switches comprising a semiconductor switch.

10. The array of claim 9, each semiconductor switch comprising a thyristor.

11. The array of claim 10, each unit cell further including a first layer and a second layer of a dielectric material having a low dielectric constant, the first layer of dielectric material being deposited upon the substrate, and the second layer of dielectric material being deposited upon the first layer of dielectric material, wherein
the row trace included within each unit cell is fabricated upon the substrate such that a lower loop is formed;
the column trace included within each unit cell is fabricated upon the second layer of dielectric material such that an upper loop is formed;
the first layer of dielectric material acts as an insulating layer in between the upper loop and the lower loop; and
a combination of the upper loop and the lower loop in each unit cell effects the inductive coupling associated with the switch included within the same unit cell.

12. The array of claim 8, the substrate comprising gallium arsenide.

13. An apparatus for providing a switching capability in a telecommunications system, comprising:
a plurality of means for accepting incoming signals, the means for accepting incoming signals being arranged substantially in parallel to each other, and each of the plurality of means for accepting incoming signals having a characteristic impedance substantially equal to Z₀;
a plurality of means for propagating outgoing signals, the means for propagating outgoing signals being arranged substantially perpendicularly to the means for accepting incoming signals so as to form an intersection between each of the plurality of means for accepting incoming signals and each of the plurality of means for propagating outgoing signals, and each of the plurality of means for propagating outgoing signals having a characteristic impedance substantially equal to Z₀;
a plurality of means for switching, each of said intersections including one of the plurality of means for switching, each of the plurality of means for switching being switchable between an ON state and an OFF state, and each of the plurality of means for switching having a characteristic parasitic capacitance substantially equal to Cₘ when in the OFF state; and
a plurality of means for providing mutual inductance, each of the plurality of means for providing mutual inductance being associated with one of the plurality of means for switching, and each of the plurality of means for providing mutual inductance having a characteristic inductance substantially equal to Lₘ;
wherein the value of Lₘ is chosen so as to compensate for the parasitic capacitances such that suppression of crosstalk within the apparatus is increased.

14. The apparatus of claim 13, wherein Lₘ is chosen such that the equation Lₘ/Cₘ=Z₀² is satisfied.

15. The apparatus of claim 14, the apparatus having two operational modes, including an even transverse electromagnetic (TEM) mode and an odd TEM mode, and the even TEM mode being associated with a characteristic impedance substantially equal to Zₑᵥₑₙ, and the odd TEM mode being associated with a characteristic impedance substantially equal to Z_{odd},
wherein the equation Zₑᵥₑₙ*Z_{odd}=Z₀² is satisfied.

16. The apparatus of claim 13, the choice of the value of Lₘ so as to compensate for the parasitic capacitances such that suppression of crosstalk within the apparatus is increased comprising a choice of the value of Lₘ such that backwards coupling of the crosstalk occurs and the crosstalk is absorbed by a plurality of means for terminating.

17. The apparatus of claim 16, wherein when Z₀=approximately 50 Ω and Cₘ=approximately 10 fF, Lₘ is chosen to be approximately equal to 25 pH.

18. The apparatus of claim 13, each of the plurality of means for switching having a characteristic series resistance substantially equal to Rₒₙ when in the ON state, and a local impedance substantially equal to Z_{local} being effected at each of the plurality of means for switching when in the ON state;
wherein Rₒₙ is chosen such that a mismatch between the local impedance Z_{local} and the characteristic impedance Z₀ of each of the plurality of means for accepting incoming signals and means for propagating outgoing signals is reduced.

19. The apparatus of claim 18, wherein when Z₀=approximately 50 Ω and Cₘ=approximately 10 fF, Lₘ is chosen to be approximately equal to 25 pH, and Rₒₙ is chosen to be approximately equal to 21 Ω.

20. A method of increasing suppression of crosstalk in a telecommunications switching array, the array including:
a plurality of first transmission lines for accepting incoming signals, the first transmission lines being arranged substantially in parallel to each other, each of the plurality of first transmission lines having a characteristic impedance substantially equal to Z₀;
a plurality of second transmission lines for propagating outgoing signals, the second transmission lines being arranged substantially perpendicularly to the first transmission lines so as to form an intersection between each of the plurality of first transmission lines and each of the plurality of second transmission lines, and each of the plurality of second transmission lines having a characteristic impedance substantially equal to Z₀; and
a plurality of switches, each of said intersections including one of the plurality of switches, each of the plurality of switches being switchable between an ON state and an OFF state, and each of the plurality of switches having a characteristic parasitic capacitance substantially equal to Cₘ when in the OFF state,
the method comprising the steps of:
providing each of the plurality of switches with an inductive coupling having a characteristic inductance substantially equal to Lₘ; and
selecting a value of Lₘ so as to compensate for the parasitic capacitances within the array.

21. The method of claim 20, wherein selecting a value of Lₘ comprises satisfying the equation Lₘ/Cₘ=Z₀².

22. The method of claim 21, the array having an even transverse electromagnetic (TEM) mode and an odd TEM mode, and the even TEM mode being associated with a characteristic impedance substantially equal to Zₑᵥₑₙ, and the odd TEM mode being associated with a characteristic impedance substantially equal to Z_{odd}, and the method further comprising the step of satisfying the equation Zₑᵥₑₙ*Z_{odd}=Z₀².

23. The method of claim 20, wherein the step of selecting a value of Lₘ so as to compensate for the parasitic capacitances within the array comprises selecting a value of Lₘ such that backwards coupling of crosstalk occurs and the crosstalk is absorbed by a plurality of transmission line terminators.

24. The method of claim 23, wherein when Z₀=approximately 50 Ω and Cₘ=approximately 10 fF, the step of selecting a value of Lₘ so as to compensate for the parasitic capacitances within the array comprises selecting Lₘ to be approximately equal to 25 pH.

25. The method of claim 20, each of the plurality of switches having a characteristic series resistance substantially equal to Rₒₙ when in the ON state, and a local impedance substantially equal to Z_{local} being effected at each of the plurality of switches when in the ON state, and
the method further comprising the step of selecting a value of Rₒₙ such that a mismatch between the local impedance Z_{local} and the characteristic impedance Z₀ of each of the plurality of first and second transmission lines is reduced.

26. The method of claim 25, wherein when Z₀=approximately 50 Ω and Cₘ=approximately 10 fF, the step of selecting a value of Lₘ so as to compensate for the parasitic capacitances within the array comprises selecting Lₘ to be approximately equal to 25 pH, and the step of selecting a value of Rₒₙ such that a mismatch between the local impedance Z_{local} and the characteristic impedance Z₀ of each of the plurality of first and second transmission lines is reduced comprises selecting Rₒₙ to be approximately equal to 21 Ω.

27. The method of claim 20, further comprising the step of implementing the array as a multilevel monolithic integrated circuit having a substrate, the circuit including a plurality of unit cells, wherein each unit cell includes:
one of the plurality of switches;
a row trace associated with one of the plurality of first transmission lines; and
a column trace associated with one of the plurality of second transmission lines.

28. The method of claim 27, each of the plurality of switches comprising a semiconductor switch.

29. The method of claim 28, each semiconductor switch comprising a thyristor.

30. The method of claim 29, each unit cell further including a first layer and a second layer of a dielectric material having a low dielectric constant, the first layer of dielectric material being deposited upon the substrate, and the second layer of dielectric material being deposited upon the first layer of dielectric material, wherein the step of implementing the array as a multilevel monolithic integrated circuit comprises the steps of:
fabricating the row trace included within each unit cell upon the substrate such that a lower loop is formed;
fabricating the column trace included within each unit cell upon the second layer of dielectric material such that an upper loop is formed;
using the first layer of dielectric material as an insulating layer in between the upper loop and the lower loop; and
combining the upper loop and the lower loop in each unit cell to effect the inductive coupling associated with the switch included within the same unit cell.

31. The method of claim 27, the substrate comprising gallium arsenide.
